(19) United States
(12) Patent Application Publication
(10) Pub. No.: US 2011/0078288 A1
(43) Pub. Date: Mar. 31, 2011

(54) NETWORK UNIT AND METHOD FOR EXECUTING A FUNCTION OF A NETWORK TERMINATION UNIT USING THE SAME

(75) Inventor: BIN-RONG CHEN, Tu-Cheng (TW)

(73) Assignee: HON HAI PRECISION INDUSTRY CO., LTD., Tu-Cheng (TW)

(21) Appl. No.: 12/641,572

(22) Filed: Dec. 18, 2009

(30) Foreign Application Priority Data
Sep. 29, 2009 (CN) 200910307987.0

(51) Int. Cl. G06F 15/177

(52) U.S. Cl. 709/220

(57) ABSTRACT

A network unit and method for executing a function of a network termination unit include computing hash values corresponding to configuration parameters, confirming function pointers of functions corresponding to the configuration parameters, and inserting the hash values and the function pointers into a hash table. The network unit and method further include computing a hash value of a configuration parameter name acquired from a configuration command, confirming a function pointer corresponding to the hash value if the hash table includes the hash value, and executing a function corresponding to the function pointer.

### BACKGROUND

1. Technical Field

Embodiments of the present disclosure relate to function execution, and more particularly to a network unit and method for executing a function of a network termination unit (NTU).

2. Description of Related Art

NTUs are frequently used in home and office applications, such as computers, phones, and digital televisions, for example. Each NTU provides various functions, such as to watch Internet Protocol television (IPTV), dial voice over Internet Protocol (VoIP) phone, for example. Generally, based on a customer premises equipment (CPE) WAN management protocol (e.g., TR-069), an operations support system (OSS) and an automatic configuration server (ACS) may be connected with a network unit (e.g., a home gateway), so as to transmit a configuration command to the NTUs and execute a function corresponding to the configuration command at the NTUs through the network unit. The configuration command may be used to upgrade software and/or hardware of the NTUs, monitor states and capabilities of the NTUs, for example. Thus, it is important to implement the functions or manage configuration parameters corresponding to the functions of the NTUs efficiently and quickly.

What is needed, therefore, is an improved network unit and method for executing a function of a NTU.

### BRIEF DESCRIPTION OF THE DRAWINGS

FIG. 1 is a block diagram of one embodiment of a network unit in communication with a plurality of NTUs.

FIG. 2 is a block diagram of one embodiment of the network unit of FIG. 1 including an executing system.

FIG. 3 is a schematic diagram of one embodiment of an exemplary program to compute hash values.

FIG. 4 is a flowchart of one embodiment of a method for executing a function of the NTU using the network unit of FIG. 2.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM.

It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

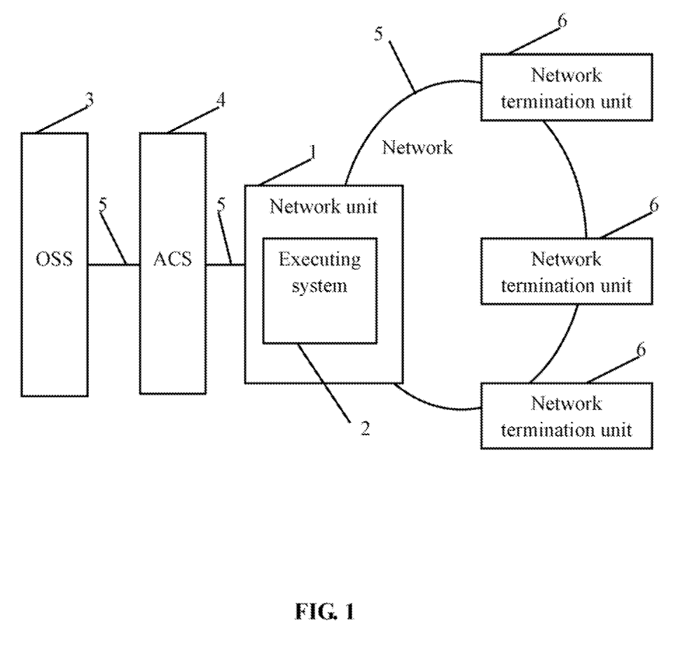

FIG. 1 is a block diagram of one embodiment of a network unit 1 in communication with a plurality of network termination units (NTUs) 6. FIG. 1 shows an example of a network frame based on a customer premises equipment (CPE) WAN management protocol (e.g., TR-069). An operations support system (OSS) 3 and an automatic configuration server (ACS) 4 are connected with the network unit 1 through a network 5, so as to transmit a configuration command to the NTU 6 and execute the configuration command at the NTU 6.

The network unit 1 includes an executing system 2. The executing system 2 may be used to execute a function of the configuration command sent to the NTU 6. By utilizing the executing system 2, the function of the NTU 6 may be searched quickly and executed efficiently. Detailed examples are provided as below.

In one embodiment, the network unit 1 may be a home gateway, and the NTU 6 may be a network storage unit, a computer, a telephone adapter, or a set top box (STB), for example. Functions of the configuration command may be operable to configure parameters of the NTU 6, upgrade software and/or hardware of the NTU 6, monitor states and capabilities of the NTU 6, and/or diagnose malfunctions of the NTU 6. The network 5 may be the Internet, or other kinds of communication networks.

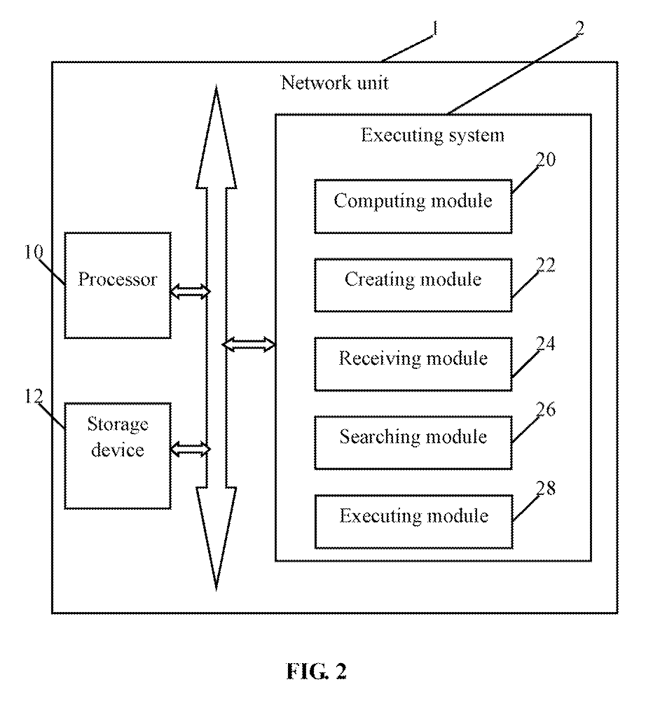

FIG. 2 is a block diagram of one embodiment of the network unit 1 including the executing system 2. The network unit 1 may include a processor 10 and a storage device 12. The processor 10 executes one or more computerized operations of the network unit 1 and other applications, to provide functions of the network unit 1. The storage device 12 stores one or more programs, such as programs of an operating system, other applications of the network unit 1, and various kinds of data, such as configuration parameters of the NTU 6, for example. In one embodiment, the storage device 12 may be a memory of the network unit 1 (e.g., a hard disk) or an external storage device, such as a memory stick, a mobile hard disk, or any other type of memory card.

In one embodiment, the alarm system 2 includes a computing module 20, a creating module 22, a receiving module 24, a searching module 26, and an executing module 28. The modules 20, 22, 24, 26, and 28 may comprise one or more computerized codes to be executed by the processor 10 to perform one or more operations of the network unit 1. Details of these operations will be provided below.

The creating module 22 creates a hash table. In one embodiment, the hash table is created by using a hashing function/algorithm to hash keys into hash buckets.

Each of the buckets is a list of key-value pairs. Since different keys may hash to a same bucket, the goal of hash table design is to spread out the key-value pairs evenly with each bucket including as few key-value pairs as possible. When an item is looked up, a key of the item is hashed to find an appropriate bucket. Then, the bucket is searched according to the corresponding key-value pair.

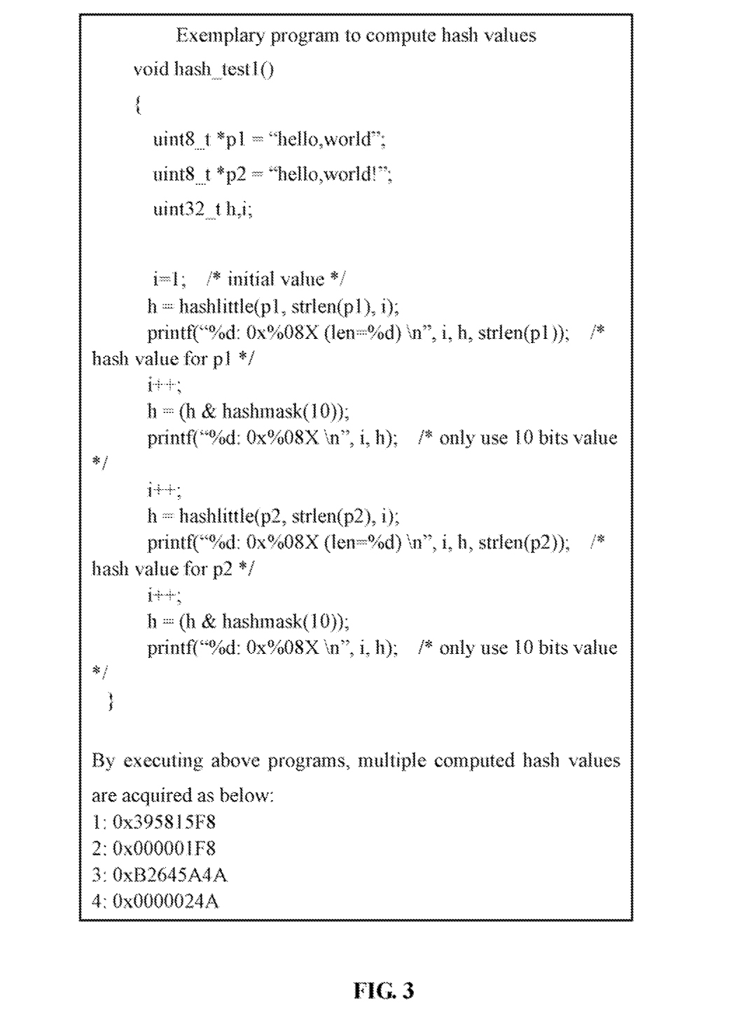

The computing module 20 acquires the configuration parameters of the NTU 6, and computes a hash value of each name of the configuration parameters. FIG. 3 shows an example of a hash function to compute the hash value of a name of a configuration parameter. The hash function as shown in FIG. 3 is “uint32_t hashlittle(const void*key, size_t length, uint32_t initval).” The hash value is computed as an integer having 32 bits by utilizing the hash function. The hash value may be decided according to a size of the hash table, and the size of the hash table may be decided according to an amount of the configuration parameters of the NTU 6.

In one embodiment, an amount of the key-value pairs of the hash table is not less than the amount of the configuration parameters of the NTU 6. For example, the amount of the configuration parameters of the NTU 6 is 1500. Since 2¹⁰ (1024)<1500<2¹¹ (2048), the amount of the key-value pairs may be determined as 2048. If each value in the hash table is 4 bits, and each key in the hash table is 4 bits, then the size of the hash table is “2048*(4+4)=16384” bits, and the hash value is 11 bits because 2¹¹=2048.

According to an example shown in FIG. 3, the bits of the hash value may be determined according to “h=(h & hashmask(*)).” The “*” represents designated bits of the hash value, for example, the “*” may be 11. That is, the hash value is 11 bits. The program shown in FIG. 3 may compute character strings having different lengths.

For example, a name of a configuration parameter is “hello,world” and the length of “hello,world” is 11 bits, and a name of a configuration parameter is “hello,world!” and the length of “hello,world!” is 12 bits.

The computed hash values corresponding to “hello,world” are “0x395815F8” and “0x000001F8.” The hash value of “0x395815F8” is an unabridged result, and the hash value of “0x000001F8” is a result having the designated bits “10” by using “h=(h & hashmask(10)).” In one embodiment, the hash value of “0x000001F8” is a result to be inserted in the hash table.

The creating module 22 confirms a function of each of the configuration parameters in the NTU 6, and acquires a function pointer of the function. The creating module 22 further inserts the hash value and the function pointer corresponding to each of the configuration parameters into the hash table. In one embodiment, the hash value of each name of the configuration parameters in the NTU 6 is regarded as an index in the hash table, so as to locate a corresponding function pointer.

In one embodiment, the functions of the configuration parameters may include, but are not limited to, abilities to access, define, or modify the configuration parameters.

The creating module 22 further stores the hash values, the function pointers, and the hash table in the storage device 12.

The receiving module 24 receives a configuration command from an external device, and acquires one or more configuration parameter names from the configuration command. The external device may be a remote server, or a remote computer, for example. As mentioned above, the configuration command may be used to configure parameters of the NTU 6, upgrade software and/or hardware of the NTU 6, monitor states and capabilities of the NTU 6, and/or diagnose malfunctions of the NTU 6.

The computing module 20 computes a hash value of each of the one or more configuration parameter names acquired from the configuration command. In one embodiment, if the one or more configuration parameter names include a serial number, such as “A.1,” the computing module 20 ignores the serial number, and computes the hash values according to the one or more configuration parameter names.

The searching module 26 determines if the hash table includes the hash value of each of the one or more configuration parameter names.

If the hash table includes the hash value of each of the one or more configuration parameter names, the executing module 28 confirms a function pointer corresponding to the hash value. The executing module 28 further invokes a function corresponding to the function pointer thereby executing the configuration command.

If the hash table does not include the hash value of each of the one or more configuration parameter names, the searching module 26 returns a prompt message to the external device. In one embodiment, the prompt message may be “no corresponding configuration parameter can be located in the NTU 6.”

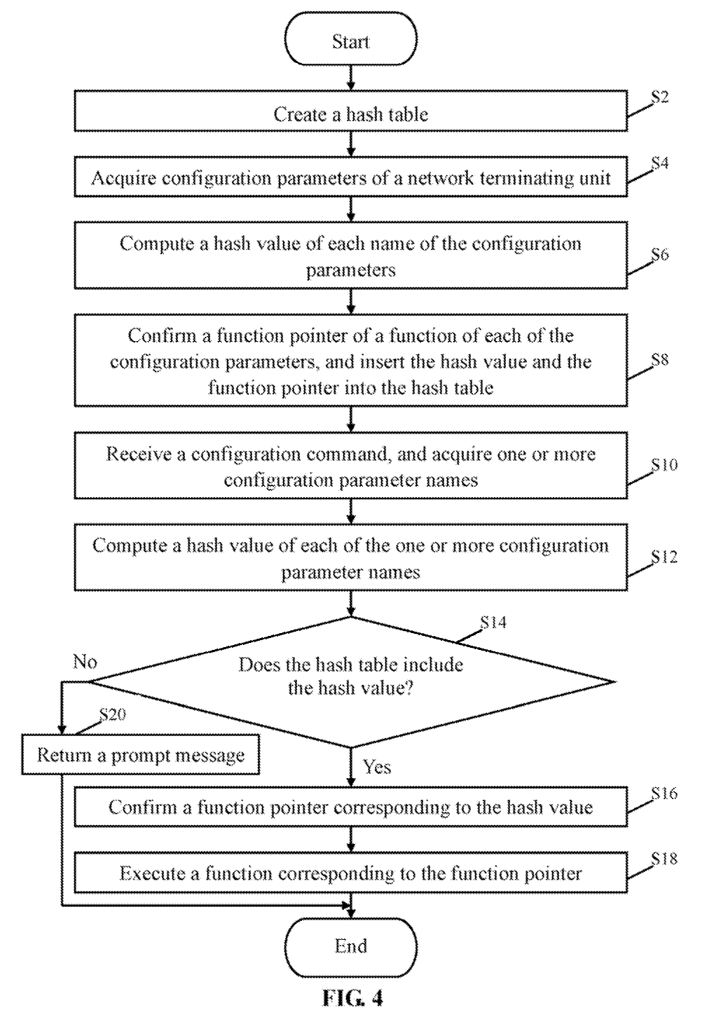

FIG. 4 is a flowchart of one embodiment of a method for executing a function of the NTU 6 using the network unit 1 of FIG. 2. Depending on the embodiment, additional blocks may be added, others removed, and the ordering of the blocks may be replaced.

In block S2, the creating module 22 creates a hash table.

In block S4, the computing module 20 acquires the configuration parameters of the NTU 6.

In block S6, the computing module 20 computes a hash value of each name of the configuration parameters.

In block S8, the creating module 22 confirms a function of each of the configuration parameters in the NTU 6, acquires a function pointer of the function, and inserts the hash value and the function pointer corresponding to each of the configuration parameters into the hash table. In one embodiment, the hash value of each name of the configuration parameters in the NTU 6 is regarded as an index in the hash table, so as to locate a corresponding function pointer.

In block S12, the receiving module 24 receives a configuration command from an external device, and acquires one or more configuration parameter names from the configuration command. As mentioned above, the external device may be a remote server, or a remote computer, for example.

In block S12, the computing module 20 computes a hash value of each of the one or more configuration parameter names acquired from the configuration command.

In block S14, the searching module 26 determines if the hash table includes the hash value of each of the one or more configuration parameter names.

If the hash table includes the hash value of each of the one or more configuration parameter names, in block S16, the executing module 28 confirms a function pointer corresponding to the hash value.

In block S18, the executing module 28 invokes a function corresponding to the function pointer thereby executing the configuration command.

If the hash table does not include the hash value of each of the one or more configuration parameter names, in block S20, the searching module 26 returns a prompt message to the external device. As mentioned above, the prompt message may be “no corresponding configuration parameter can be located in the NTU 6.”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for executing functions of a network termination unit (NTU) using a network unit, the network unit in communication with an external device and the NTU, the method comprising:
acquiring configuration parameters of the NTU using the network unit, and computing a hash value of each name of the configuration parameters;
confirming a function of each of the configuration parameters, and acquiring a function pointer of the function;
creating a hash table, and inserting the hash value and the function pointer corresponding to each of the configuration parameters into the hash table;
receiving a configuration command by the network unit from the external device, and acquiring one or more configuration parameter names from the configuration command;
computing a hash value of each of the one or more configuration parameter names acquired from the configuration command;
determining if the hash table comprises the hash value of each of the one or more configuration parameter names;
confirming a function pointer by the network unit if the hash table comprises the hash value of each of the one or more configuration parameter names; and
executing a function corresponding to the function pointer at the NTU using the network unit.

2. The method according to claim 1, further comprising:
storing the hash table in a storage device of the network unit.

3. The method according to claim 1, further comprising:
returning a prompt message if the hash table does not comprise the hash value of each of the one or more configuration parameter names.

4. The method according to claim 1, wherein the hash value of each name of the configuration parameters in the NTU is an index in the hash table to locate a corresponding function pointer.

5. The method according to claim 1, wherein the network unit is a network storage unit, a computer, a telephone adapter, or a set top box (STB).

6. The method according to claim 1, wherein the configuration command is operable to configure parameters of the NTU, upgrade software and/or hardware of the NTU, monitor states and capabilities of the NTU, and/or diagnose malfunctions of the NTU.

7. A network unit, the network unit in communication with a network termination unit (NTU) and an external device, the network unit comprising:
a storage device;
at least one processor; and
one or more programs stored in the storage device and being executable by the at least one processor, the one or more programs comprising:
a computing module operable to acquire configuration parameters of the NTU, and compute a hash value of each name of the configuration parameters;
a creating module operable to confirm a function of each of the configuration parameters and acquire a function pointer of the function, create a hash table, and insert the hash value and the function pointer corresponding to each of the configuration parameters into the hash table;
a receiving module operable to receive a configuration command from the external device, and acquire one or more configuration parameter names from the configuration command;
the computing module further operable to compute a hash value of each of the one or more configuration parameter names acquired from the configuration command;
a searching module operable to determine if the hash table comprises the hash value of each of the one or more configuration parameter names; and
an executing module operable to confirm a function pointer if the hash table comprises the hash value of each of the one or more configuration parameter names, and execute a function corresponding to the function pointer.

8. The network unit according to claim 7, wherein the creating module is further operable to store the hash table in the storage device of the network unit.

9. The network unit according to claim 7, wherein the searching module is further operable to return a prompt message if the hash table does not comprise the hash value of each of the one or more configuration parameter names.

10. The network unit according to claim 7, wherein the hash value of each name of the configuration parameters in the NTU is an index in the hash table to locate a corresponding function pointer.

11. The network unit according to claim 7, wherein the network unit is a network storage unit, a computer, a telephone adapter, or a set top box (STB).

12. The network unit according to claim 7, wherein the configuration command is operable to configure parameters of the NTU, upgrade software and/or hardware of the NTU, monitor states and capabilities of the NTU, and/or diagnose malfunctions of the NTU.

13. A storage medium storing a set of instructions, the set of instructions capable of being executed by a processor to perform a method for executing functions of a network termination unit (NTU) using a network unit, the network unit in communication with an external device and the NTU, the method comprising:
acquiring configuration parameters of the NTU using the network unit, and computing a hash value of each name of the configuration parameters;
confirming a function of each of the configuration parameters, and acquiring a function pointer of the function;
creating a hash table, and inserting the hash value and the function pointer corresponding to each of the configuration parameters into the hash table;
receiving a configuration command by the network unit from the external device, and acquiring one or more configuration parameter names from the configuration command;
computing a hash value of each of the one or more configuration parameter names acquired from the configuration command;
determining if the hash table comprises the hash value of each of the one or more configuration parameter names;
confirming a function pointer by the network unit if the hash table comprises the hash value of each of the one or more configuration parameter names; and
executing a function corresponding to the function pointer at the NTU using the network unit.

14. The storage medium as claimed in claim 13, wherein the method further comprises:
storing the hash table in a storage device of the network unit.

15. The storage medium as claimed in claim 13, wherein the method further comprises:
returning a prompt message if the hash table does not comprise the hash value of each of the one or more configuration parameter names.

16. The storage medium as claimed in claim 13, wherein the hash value of each name of the configuration parameters in the NTU is an index in the hash table to find a corresponding function pointer.

17. The storage medium as claimed in claim 13, wherein the network unit is a network storage unit, a computer, a telephone adapter, or a set top box (STB).

18. The storage medium as claimed in claim 13, wherein the configuration command is operable to configure parameters of the NTU, upgrade software and/or hardware of the NTU, monitor states and capabilities of the NTU, and/or diagnose malfunctions of the NTU.
